(19) United States
(12) Patent Application Publication
(10) Pub. No.: US 2002/0090422 A1
(43) Pub. Date: Jul. 11, 2002

(54) Method of configuring a slice of a pizza-type pie and an apparatus for preparing a pizza-type pie

(76) Inventors: Mark DeRaud, Fresno, CA (US); Adam Gambel, Lafayette, CA (US)

Correspondence Address: DERGOSITS & NOAH LLP, Suite 1150, Four Embarcadero Center, San Francisco, CA, 94111, US

(21) Appl. No.: 09/954,491

(22) Filed: Sep. 11, 2001

Related U.S. Application Data
(60) Provisional application No. 60/231,803, filed on Sep. 11, 2000.

(51) Int. Cl. A23G 3/00

(52) U.S. Cl. 426/94

(57) ABSTRACT

The present invention is directed to a method of configuring a slice of a pizza-type pie, which is at least partially baked. The method includes (i) folding an end portion of the slice in a transverse direction so that upon folding the top of the end portion is folded onto the top of the remainder of the slice, and (ii) folding the resulting slice in a lengthwise direction so that the top of the resulting slice is folded onto itself. This method can be applied to slice that is in a shape selected from the group consisting of a wedge shape, a substantially round shape, and a substantially square shape. In another embodiment, the present invention is directed to application of the above-described method to a slice of a pizza-type pie having an end portion that is substantially free of toppings.

In another embodiment, the present invention is directed to a pizza-type pie having a crust, sauce on top of the surface of the crust, and toppings also on top of the surface of the crust, wherein an inner minority portion of the surface area of the pizza is substantially free of toppings.

### CROSS-REFERENCE TO RELATED APPLICATION

This application claims priority to provisional patent application serial No. 60/231,803 filed on Sep. 11, 2000, which is incorporated herein by reference in its entirety.

### FIELD OF INVENTION

The present invention relates to a method of configuring a planar food product. In particular, the present invention relates to a method of providing a pizza pie crust-based food product for consumption with decreased spillage of the food contents.

### BACKGROUND OF THE INVENTION

Pizza-type pies have become a popular food item throughout the world. A pizza-type pie typically includes a thin crust, a sauce on top of the crust, and various toppings on top of the sauce. After the sauce and toppings are placed on the crust, the entire combination is then baked in an oven at high heat, typically at temperatures of greater than about 100° C. The baked pizza-type pie is typically served flat and open-faced, i.e., with the toppings on top and the crust on the bottom. When the pizza-type pie is large enough to serve more than one person, it is cut into smaller pieces.

Even after the cutting process, the slices of the pizza-type pie are typically very hot with a semi-fluid mixture of the toppings and sauce on top of the baked crust. Consumption of this unstable and potentially messy food product requires a combination of dexterity and coordination to bring the flexible slice to the mouth without spilling any of the semi-fluid mixture of toppings and sauce. One method of consumption is to use a plate and silverware. A more prevalent method is to consume the slice with the hands, i.e., without silverware. In this method, the slice is typically consumed using two hands, one hand supporting an outer end, e.g., the crust end, and the other hand supporting the other sagging end, e.g., the pointed end of a wedge-shaped slice. Some consumers eat the slice by utilizing a length-wise fold dividing the slice into symmetrical halves down the center of the slice to form a V-shaped configuration. Still other consumers consume the slice by folding the pointed end of a wedge-shaped slice towards the crust end. These methods of consuming the known configurations of a slice, however, have the disadvantage of a high likelihood for spillage of the toppings and sauce. Accordingly, these methods restrict the consumption of pizza-type pies to a sit-down meal, because these methods either require use of two hands or the use of silverware.

Pizza-type pie alternatives are also known in the art. Such alternatives include calzones, pizza burritos, and other enclosed configurations. However, these alternatives have the disadvantage of deviating from the traditional satisfying taste of the pizza-type pie that is baked with an open face. Furthermore, these alternatives can require additional baking or cooking steps and/or additional ingredients, as compared with the traditional pizza-type pie.

It would, therefore, be advantageous to provide a configuration of the slice of a pizza-type pie that provides a solution to these disadvantages. Accordingly, an object of the present invention is to provide a configuration of a slice of a pizza-type pie that minimizes spillage of the toppings and sauce. Still another object is to provide a configuration of a slice of pizza-type pie that is conducive to consumption by utilizing only one hand. These objects and advantages are described herein in detail.

### SUMMARY OF THE INVENTION

The present invention is directed to a method of configuring a slice of a pizza-type pie, which is at least partially baked. The method includes (i) folding an end portion of the slice in a transverse direction so that upon folding the top of the end portion is folded onto the top of the remainder of the slice, and (ii) folding the resulting slice in a lengthwise direction so that the top of the resulting slice is folded onto itself. This method can be applied to slice that is in a shape selected from the group consisting of a wedge shape, a substantially round shape, and a substantially square shape

In another embodiment, the present invention is directed to application of the above-described method to a slice of a pizza-type pie having an end portion that is substantially free of toppings. Th method includes (i) folding an end portion of the slice, which end portion is substantially free of toppings, in a transverse direction so that the top of the end portion is folded onto the top of the remainder of the slice, which remainder has one or more toppings, and (ii) folding the resulting slice in a lengthwise direction so that the top of the resulting slice is folded onto itself. The end portion can also be substantially free of sauce and toppings. The present invention is also directed to the slice configurations obtained from the above-described method.

In another embodiment, the present invention is directed to a pizza-type pie having a crust, sauce on top of the surface of the crust, and toppings also on top of the surface of the crust, wherein an inner minority portion of the surface area of the pizza is substantially free of toppings. The inner minority portion can further be substantially free of sauce. In a substantially round pizza-type pie, the pie only has toppings and sauce covering an annular region of the crust, where the inner central region of the crust is substantially free of toppings. In a substantially square pizza-type pie the toppings and sauce cover one or more rectangular regions of the crust, wherein one or more inner rectangular regions of the crust is substantially free of toppings. The resulting slices of the pizza-type pies of this embodiment have a minor portion of the crust that is substantially free of toppings, and toppings and sauce on the remainder of the crust.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with to the accompanying drawings, in which:

FIGS. 1A-1F illustrate one embodiment of applying the method of the present invention to a wedge-shaped slice of a pizza-type pie;

FIGS. 2A-2D illustrate another embodiment of applying the method of the present invention to a substantially round-shaped slice of a pizza-type pie;

FIGS. 3A-3D illustrate another embodiment of applying the method of the present invention to a substantially square-shaped slice of a pizza-type pie;

FIGS. 4A-4C illustrate another embodiment of applying the method of the present invention to a wedge-shaped slice of a pizza-type pie having a portion thereof free from toppings;

FIGS. 5A-5C illustrate another embodiment of applying the method of the present invention to a substantially square-shaped slice of a pizza-type pie having a portion thereof free from toppings;

FIGS. 6A-6C illustrate another embodiment of applying the method of the present invention to a substantially round-shaped slice of a pizza-type pie having a portion thereof free from toppings;

FIGS. 7A-7D illustrate an embodiment of a substantially-round pizza-type pie prepared according the present invention;

FIGS. 8A-8D illustrate another embodiment of a substantially square pizza-type pie prepared according to the present invention;

FIG. 9A illustrates a side view of an apparatus according to the present invention;

FIG. 9B illustrates a top view of an apparatus according to the present invention;

FIG. 9C illustrates a magnified view of one cut-away portion of an apparatus according to the present invention; and

FIG. 9D illustrates a perspective view of an apparatus according to the present invention.

### DETAILED DESCRIPTION OF THE INVENTION

The present invention is directed to a method of applying a perpendicular fold to a slice of a pizza-type pie to provide a configuration that minimizes spillage of the toppings and/or sauce. The present invention is also directed to a pizza-type pie having a portion thereof that is substantially free of toppings and/or sauce. A slice of such a pizza-type pie can then be configured according the method of the present invention to minimize the spillage of the toppings and/or sauce. Lastly, the present invention is directed to an apparatus, and a method of using the apparatus, which provides a pizza-type pie having a portion thereof that is substantially free of toppings and/or sauce.

The term “pizza-type pie,” as used herein, means planar food item having a thin crust that is typically made of flour, which food item is at least partially baked. The pizza-type can have an edge crust after it is baked and can also be substantially free of an edge crust, i.e., toppings and/or sauce are added all the way to the edge of the baked crust. The crust is typically no more than about ½ inch thick before baking, and can be made into any geometric shape, e.g., a round or square shape. The pizza-type pie can optionally have a sauce and/or various toppings on top of the crust. Although the sauce typically includes tomatoes, it can contain any of the edible ingredients known to the skilled artisan in the culinary arts, such as seasoning. The toppings can include, but are not limited to, one or more of the following: cheese, such as mozzarella cheese, feta cheese, and goat cheese; vegetables/fruits, such as onions, tomatoes, mushrooms, bell peppers, onions, and pineapples; and meats/fish, such sausage, pepperoni, ham, bacon, chicken, turkey and anchovies. After the sauce and toppings are placed on the crust, the entire concoction is typically baked in an oven at high heat, typically at temperatures of greater than about 100° C.

When the pizza-type pie is large enough to serve more than one person, it is cut into smaller pieces. Large substantially round-shaped pies are typically cut to provide several wedge-shaped slices of approximately equal size; large substantially square-shaped pies are typically cut to provide smaller rectangular or square-shaped slices. The term “substantially round,” as used herein, means a shape that is a circle, oval, an ellipse, a polygon or any similar geometric shape thereof. The term “substantially square,” as used herein, means a shape that is a square, a rectangle, a trapezoid, a rhombus, or any similar geometric shape thereof. A personal size pizza-type pie, which can be in a substantially round or substantially square shape, typically does not require cutting into smaller pieces, since it is small enough for one serving. Accordingly, the term “slice,” as used herein, can inclusively refer to any of the aforementioned single serving configuration of a pizza-type pie, i.e., a wedge-shaped slice, a rectangular/square shaped slice, and a personal size pizza-type pie.

As discussed above, one aspect of the present invention is directed to a method of applying a perpendicular fold to a slice of a pizza-type pie, wherein the perpendicular is defined by transverse axis and a lengthwise axis in the plane of the pizza-type pie. The perpendicular fold includes (i) a transverse fold of a minority portion of the slice onto the top of the majority portion, and (ii) a lengthwise fold of the slice to form a hairpin-shaped fold along the length of the slice. It is preferred to conduct the transverse fold first, i.e., so that the toppings/sauce of the minority portion is folded onto the toppings/sauce on the majority portion, and then the lengthwise fold.

Alternatively, the lengthwise fold, i.e., dividing the slice into symmetrical halves down the center of the slice to form a hairpin-shaped fold along the length of the slice, can be conducted first in which case the transverse fold can be conducted in either direction to have the crust of the minor portion touching the crust of the majority portion. The term “a minority portion,” as used herein, means less than about 50% of the length of the slice, preferably from about 10% to about 40% of the length of the slice, and most preferably from about 20% to about 35% of the length of the slice. The term “about,” as used herein, means plus or minus 10% of the stated value.

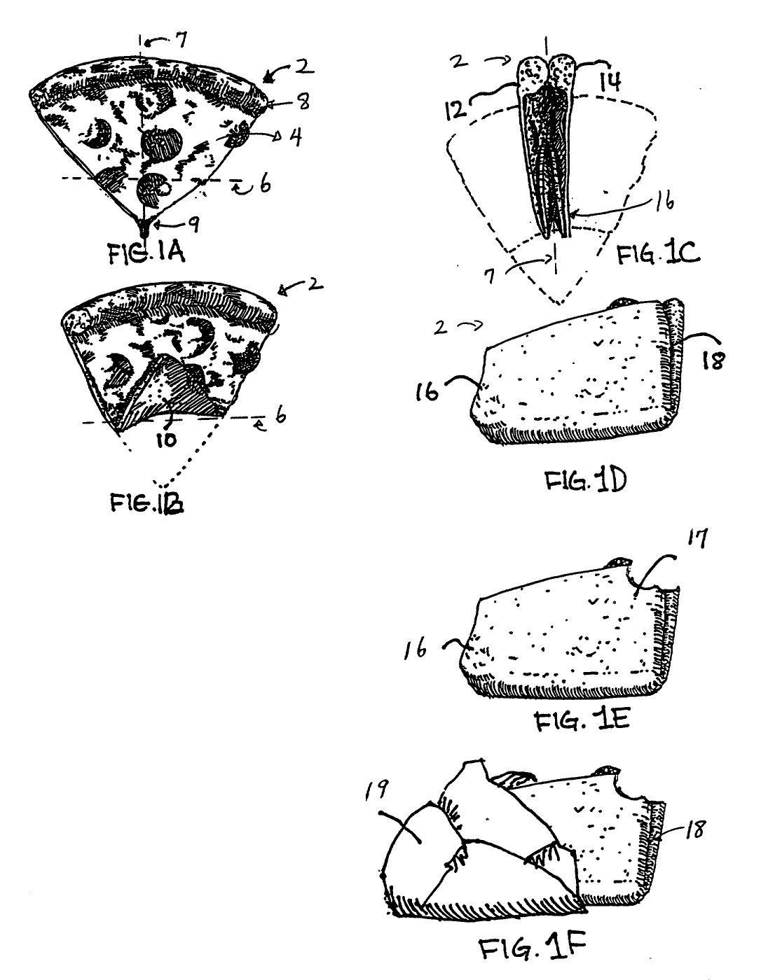

As illustrated in FIGS. 1A through 1D, one embodiment of the present invention is directed to conducting a perpendicular fold on a wedge-shaped slice 2 having toppings 4, a crust end 8, and a pointed end 9. FIGS. 1A and 1B illustrate the transverse fold along a transverse axis 6 so that a minority portion 10 is folded with the crust showing and the toppings folded onto the toppings of the majority portion. The dashed lines provided throughout the Figures show the outlines of the original slice. The transverse axis 6 can be linear or slightly arced, as illustrated in FIGS. 1B and 1C. FIGS. 1A and 1C illustrate the lengthwise fold along the lengthwise axis 7 so that the slice is folded into approximately symmetrical halves 12 and 14 to form a hairpin-shaped fold along the length of the slice. The resulting slice configuration has a folded crust end 18 and a W-shaped folded end 16, as illustrated by a top view in FIG. 1C and a perspective view in FIG. 1D. The resulting slice configuration effectively contains the toppings and/or sauce to minimize spillage. Furthermore, the resulting slice configuration can be consumed with the use of only one hand, as shown in FIG. 1E with the bite from the from the corner of the radial edge and the crust end 17.

The resulting slice configuration can be placed in an appropriate sleeve-like container or envelope 19 for consumption by the consumer. Since the slice configuration effectively contains the toppings and/or sauce, the folded slice can be placed in the container or envelope with crust end 18 pointed out for first consumption. All of the embodiments described below can be similarly packaged for sale to the consumer In an alternative embodiment (not shown), the wedge-shaped slice is first folded lengthwise along the lengthwise axis 7 so that the slice is folded into approximately symmetrical halves to form a hairpin-shaped fold along the length of the slice with the toppings of each half touching each other. Then the slice is folded along the transverse axis 6 so that a minority portion is folded in either direction with the crust of about ½ of the minority portion of the slice touching the crust of ½ the majority portion of the slice.

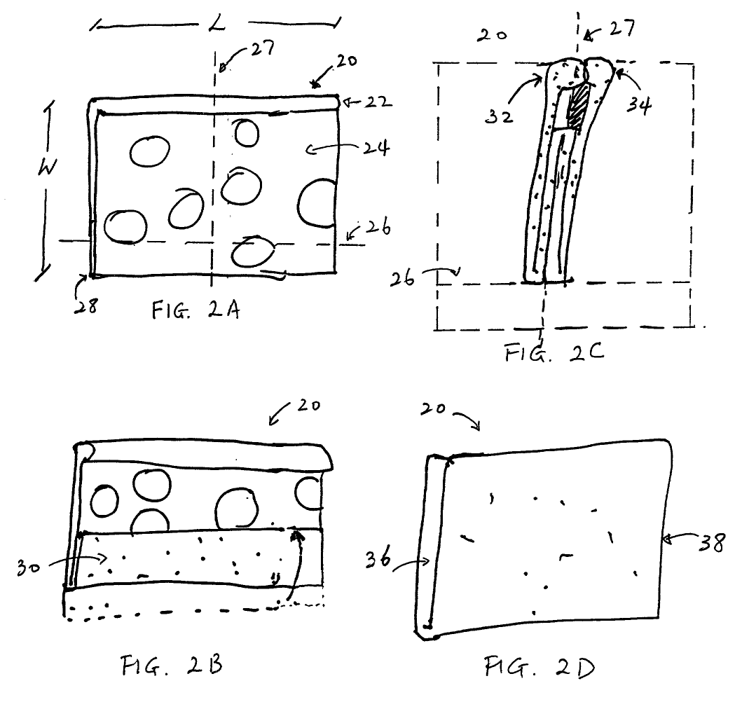

FIGS. 2A through 2D illustrate another embodiment of the present invention, wherein the perpendicular fold is applied to a substantially-square slice 20 having toppings 24, a crust end 22, and a flat end 28. As defined above, the substantially-square slice can have a length “L” and a width “W” that is about equal to each other. Alternatively, the length can be less than the width to provide a rectangular slice with a shorter crust end, or the length can be greater than the width to provide a rectangular slice with a longer crust end. The substantially-square shaped slice is provided with a crust end for illustration purposes only. Not that this method can similarly be applied to a substantially-square slice without a crust end, i.e., a substantially square slice from the middle of a pizza-type pie. FIGS. 2A and 2B illustrate the transverse fold along a transverse axis 27 so that a minority portion 30 is folded with the crust showing and the toppings folded onto the toppings of the majority portion. FIGS. 1A and 1C illustrate the lengthwise fold along the lengthwise axis 27 so that the slice is folded into approximately symmetrical halves 32 and 34 to form a hairpin-shaped fold along the length of the slice. The resulting slice configuration has a folded crust end 38 and a W-shaped folded end 36, as illustrated by a top view in FIG. 2C and a perspective view in FIG. 2D. The resulting slice configuration effectively contains the toppings and/or sauce to minimize spillage. Furthermore, the resulting slice configuration can be consumed with the use of only one hand.

As described above for the wedge-shaped slice, the substantially square-shaped slice can alternatively be folded along the lengthwise axis 27 first, followed by the transverse fold along the transverse axis 26.

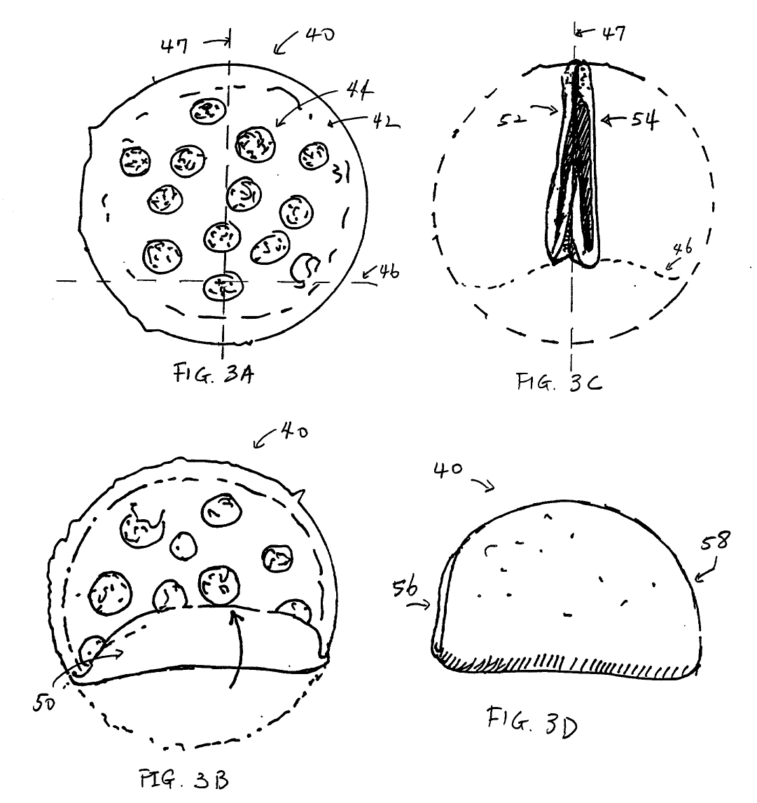

FIGS. 3A through 3D illustrate another embodiment of the present invention, wherein the perpendicular fold is applied to a substantially-round slice 40 having toppings 44 and a crust 42 along the periphery. Such substantially-round slices are typically offered as personal size pizza-type pies. Similar to the embodiment described above for the substantially-square slice without a crust end, the orientation of this embodiment is relative. Accordingly, the FIGS. 3A and 3B illustrate the transverse fold along a transverse axis 46 so that a minority portion 50 is folded with the crust showing and the toppings folded onto the toppings of the majority portion. FIGS. 3A and 3C illustrate the lengthwise fold along the lengthwise axis 47 so that the slice is folded into approximately symmetrical halves 52 and 54 to form a hairpin-shaped fold along the length of the slice. The resulting slice configuration has a folded crust end 58 and a W-shaped folded end 56, as illustrated by a top view in FIG. 3C and a perspective view in FIG. 3D. The resulting slice configuration effectively contains the toppings and/or sauce to minimize spillage. Furthermore, the resulting slice configuration can be consumed with the use of only one hand.

In another embodiment of the present invention, the perpendicular fold is applied to a slice of a pizza-type pie having a minority portion that is substantially free of toppings. The minority portion can optionally be substantially free of sauce. The term “substantially free,” as used herein, means that the referenced material is not added to the portion of the slice before baking. Accordingly, the term “substantially free” can encompass portions of a slice on which some of the toppings and sauce have migrated over during baking. Without wanting to be bound by any one theory, it is believed that a minority portion that is substantially free of toppings allows a better transverse fold.

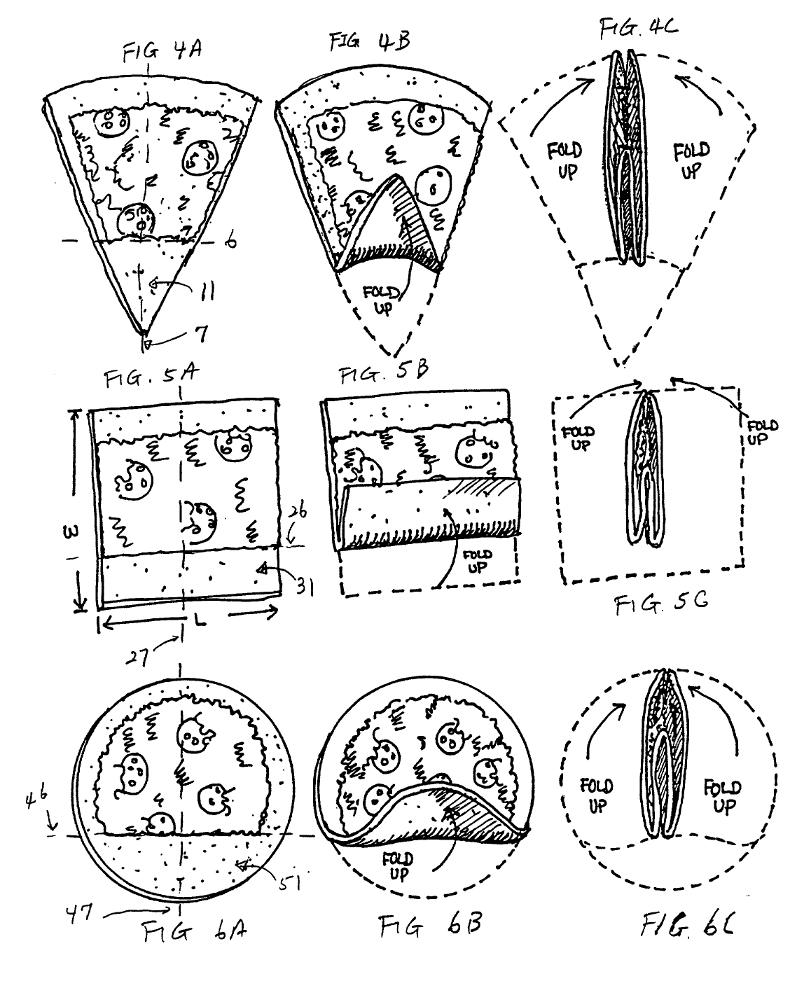

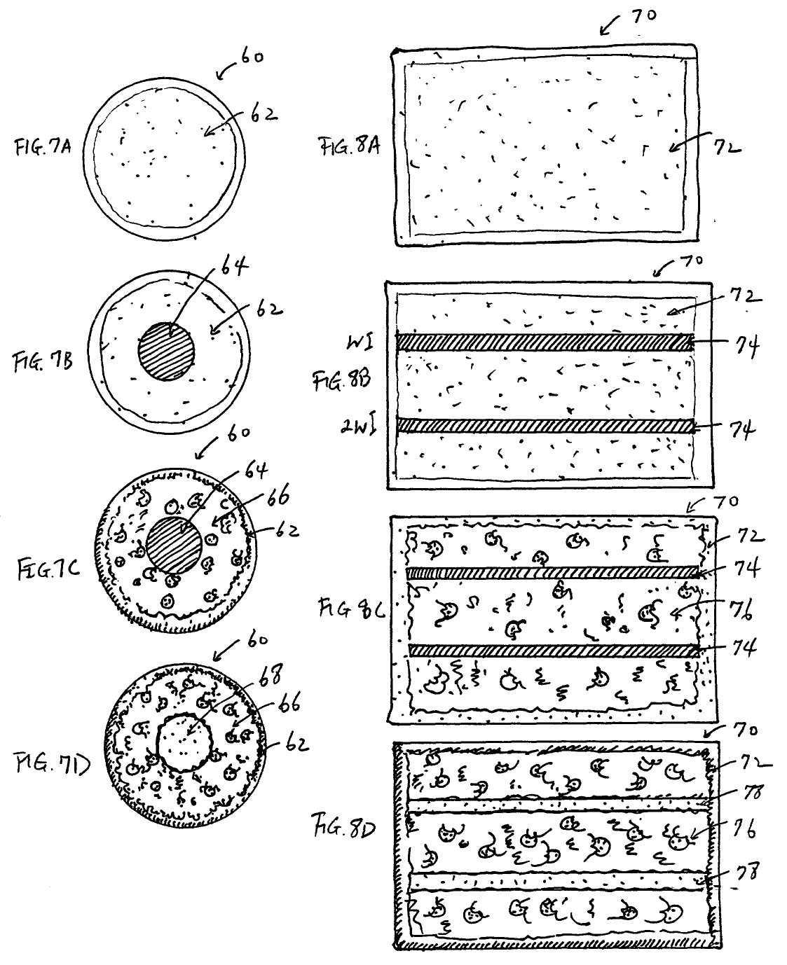

As illustrated by FIGS. 4A, 5A, and 5C, slices of the previously described geometric shapes are illustrated with a minority portion that is substantially free of toppings. FIGS. 4A through 4C illustrate the application of the perpendicular fold on a wedge-shaped slice, wherein the tip portion 11 is substantially free of toppings and/or sauce. The area where the toppings start provide the transverse axis 6 where the transverse fold is applied, as illustrated in FIG. 4B. Thereafter, the same lengthwise folded is applied along the lengthwise axis 7, as illustrated by FIG. 4C. Similarly, FIGS. 5A through 5C illustrate the application of the perpendicular fold on a substantially square slice, wherein an end portion 31 is substantially free of toppings and/or sauce. The area where the toppings start provide the transverse axis 26 where the transverse fold is applied, as illustrated in FIG. 5B. Thereafter, the same lengthwise folded is applied along the lengthwise axis 27, as illustrated in FIG. 5C. Lastly, FIGS. 6A through 6C illustrate the application of the perpendicular fold on a substantially round slice, wherein an end portion 51 is substantially free of toppings and/or sauce. The area where the toppings start provide the transverse axis 46 where the transverse fold is applied, as illustrated in FIG. 6B. Thereafter, the same lengthwise folded is applied along the lengthwise axis 47, as illustrated in FIG. 6C.

As described above, each of the embodiments illustrated in FIG. 4A-4C, 5A-5C and 6A-6C can be modified so that the lengthwise fold is conducted first, followed by the transverse fold.

In another embodiment, the present invention is also directed to a pizza-type pie having an inner minority portion that is substantially free of toppings and a method of making such a pizza-type pie. The term “substantially free,” as used herein, means that the referenced material is not added to the portion of the pie before baking. Accordingly, the term “substantially free” can encompass portions of a pie on which some of the toppings and sauce have migrated over during baking. The term “inner minority portion,” as used herein, refers to a minor surface area located within the surface area of the pizza type pie containing the toppings and/or sauce, i.e., within the periphery crust region, that is less than about 50%, preferably from about 10% to about 40%, and most preferably from about 20% to about 35% of the surface area of the pizza-type pie.

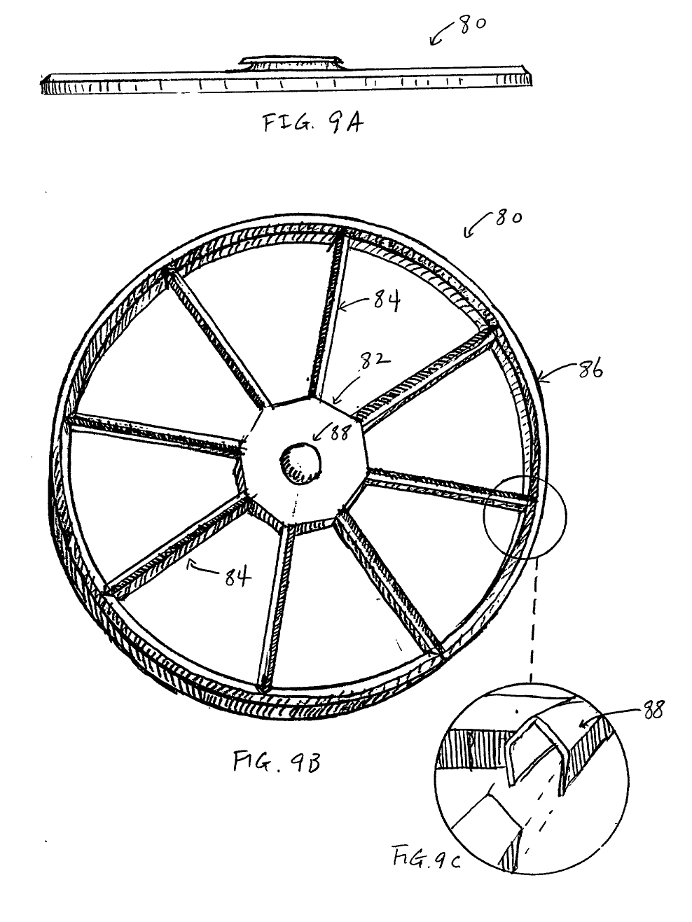

As illustrated by FIGS. 7A through 7D, a substantially-round shaped pizza-type pie 60, which has an inner minority portion 68 that is substantially free of toppings, is obtained as follows. A substantially round toppings shield 64 is placed in the middle of a substantially round pizza dough having sauce on it 62. The toppings shield is an apparatus that prevents the toppings from being added to the portion of the pizza it covers. After one or more toppings 66 are added onto the pizza dough, the uncooked pizza is then baked with the toppings shield in place. After baking, the toppings shield is removed before the pizza-type pie is divided into slices to provide an inner minority portion 68 that is substantially free of toppings. Alternatively, the toppings shield can be added onto the pizza dough before adding the sauce to provide an inner minority portion that is substantially free of toppings and sauce. Lastly, the method described above can be modified by removing the toppings shield before baking. This alternative, however, will result in some migration of toppings and/or sauce to the inner minority portion.

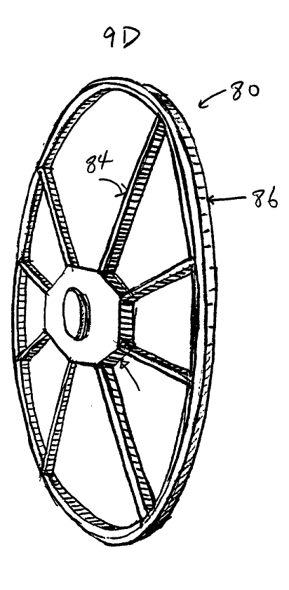

In another embodiment, FIGS. 8A through 8D illustrate a substantially-square shaped pizza-type pie 70, which has at least one inner minority portion 78 that is substantially free of toppings and a majority portion that has toppings 76. The same method is employed as described above for making the substantially-round shaped pizza-type pie. However, in this embodiment, the at least one inner minority portion is in the form of a strip 78, because the toppings shield 74 is in the form of a long strip. The toppings shield is strategically placed so that the pie can be divided into substantially-square shaped slices having a minor portion that is substantially free of toppings and/or sauce, as illustrated in FIG. 5A. For example, if the substantially square pizza-type pie is large enough to provide three rows of substantially-square shaped slices, two toppings shields in the shape of strips would be used to provide approximately equal sized rows. One toppings shield, however, would preferably be twice the width “W” of the other toppings shield, because the toppings shield having a width of “2W” would provide the minority portions, which are substantially free of toppings, for two substantially square slices in adjacent rows, as illustrated in FIG. 8B.

The toppings shield can be made of any solid material known for use in the culinary arts. Preferably, the toppings shield is made of a heat resistant material, such as aluminum or stainless steel. The toppings shield can be any shape that provides an inner minority portion that is substantially free of toppings, to thereby provide a slice having a minority portion that is substantially free of toppings, as described above. Accordingly, the toppings shield has a shape that provides the shape of the minor portion of the slice, which is substantially free of toppings and/or sauce. The height of the toppings shield can be modified to accommodate the allowable height on any of the ovens commonly used in the culinary arts.

In one embodiment, the toppings shield is in the form of a long inverted U-shaped strip for use in substantially-square shaped pizza-type pies. The cross section can also be in the shape of a house, as illustrated in FIG. 9C. The open ends of the U-shaped strip or the house-shaped strip is preferably angled inward to a small degree, i.e. less than about 2 degrees, to facilitate removal of the toppings eliminator from the baked dough, as is well understood to the skilled artisan in the culinary arts.

In another embodiment that is useful for substantially-round shaped pizza-type pies, the toppings shield includes a top portion and a substantially-cylindrical wall, wherein the top of the wall is connected to the top portion. The top portion can be substantially flat. The term “substantially-cylindrical wall,” as used herein, means that, when view from the bottom of the topping shield, the wall has the shape selected from the group consisting of a circle, oval, an ellipse, a polygon or any similar geometric shape thereof. The bottom end of the substantially-cylindrical wall is preferably angled inward to a small degree, i.e. less than about 2 degrees, to facilitate removal of the toppings eliminator from the baked dough, as is well understood to the skilled artisan in the culinary arts. The top portion of the toppings shield can optionally have a handle or a knob to facilitate use. The toppings shield is preferably in the shape of a multi-sided polygon along its periphery, wherein the number of sides corresponds to the number of slices so that a straight transverse axis is provided for the transverse fold. For example, the toppings shield would be in the shape of a hexagon if the pizza-type pie were to be divided into six slices.

In another embodiment, the toppings shield has the shape of a “hub with spokes.” The hub can include a top portion and a substantially-cylindrical wall, as described above. The spokes, which are connected to the hub, are shaped as a long inverted U-shaped strip, as described above for use in substantially-square shaped pizza-type pies. The cross section of the spokes can also be in the shape of a house, as illustrated in FIG. 9C. The ends of this embodiment, which contact the dough, are preferably angled inward to a small degree, i.e. less than about 2 degrees, to facilitate removal of the toppings eliminator from the baked dough, as is well understood to the skilled artisan in the culinary arts. The number of spokes will equal the number of slices of the substantially round pizza-type pie. Alternatively, the number of spokes can be twice the number of slices to facilitate the lengthwise fold.

In still another embodiment, the toppings shield has the shape of a cartwheel 80, as illustrated in FIGS. 9A through 9D. The cartwheel 80 includes (i) a hub 82, (ii) a plurality of spokes 84 connected on one end to the hub, and (ii) an outer wheel 86 connected to the other end of the spokes. The hub and spokes are the same as described above. As described above, the hub can include a handle or knob 88 to facilitate use. Similar to the cross-section of the spokes, the outer wheel 86 of the cartwheel can have a cross-section shaped as an inverted “U.” The cross section of the outer wheel 86 is preferably in the shape of a house 88, as illustrated in FIG. 9C. The ends of this embodiment, which contact the dough, are preferably angled inward to a small degree, i.e. less than about 2 degrees, to facilitate removal of the toppings eliminator from the baked dough, as is well understood to the skilled artisan in the culinary arts. As described above, the number of spokes can be varied. Without wanting to be limited by any one theory, it is believed that the cartwheel 80 provides a pizza-type pie that can be divided into wedge-shaped slices, which do not have toppings along all of the edges. Such a slice is believed to further minimize spillage of the toppings and/or sauce when the above-mentioned perpendicular fold is applied.

What is claimed is:

1. A method of configuring a slice of a pizza-type pie, which is at least partially baked, the method comprising:
folding an end portion of the slice in a transverse direction so that upon folding the top of the end portion is folded onto the top of the remainder of the slice; and
folding the resulting slice in a lengthwise direction so that the top of the resulting slice is folded onto itself.

2. The method of claim 1, wherein the slice is in a shape that is selected from the group consisting of a wedge shape, a substantially round shape, and a substantially square shape.

3. The method of claim 2, wherein the folded end portion that is from about 10% to about 40% of the length of the slice.

4. The method of claim 3, wherein the folded end portion is from about 20% to about 35% of the length of the slice.

5. A method of configuring a wedge-shaped slice of a pizza-type pie, which is at least partially baked, the method comprising:
folding a pointed end portion of the slice in a transverse direction so that upon folding the top of the end portion is folded onto the top of the remainder of the slice; and
folding the resulting slice in a lengthwise direction so that the top of the resulting slice is folded onto itself.

6. The method of claim 5, wherein the folded end portion that is from about 10% to about 40% of the length of the slice.

7. The method of claim 6, wherein the folded end portion is from about 20% to about 35% of the length of the slice.

8. A configuration of a slice of a pizza-type pie, which is at least partially baked, which slice is obtained from the method comprising:
folding an end portion of the slice in a transverse direction so that upon folding the top of the end portion is folded onto the top of the remainder of the slice; and
folding the resulting slice in a lengthwise direction so that the top of the resulting slice is folded onto itself.

9. The product of claim 8, wherein the slice is in a shape that is selected from the group consisting of a wedge shape, a substantially round shape, and a substantially square shape.

10. The product of claim 9, wherein the folded end portion is from about 10% to about 40% of the length of the slice.

11. A configuration of a wedge-shaped slice of a pizza-type pie, which is at least partially baked, which slice is obtained from the method comprising:
folding a pointed end portion of the slice in a transverse direction so that upon folding the top of the end portion is folded onto the top of the remainder of the slice; and
folding the resulting slice in a lengthwise direction so that the top of the resulting slice is folded onto itself.

12. The product of claim 11, wherein the folded end portion that is from about 10% to about 40% of the length of the slice.

13. The product of claim 12, wherein the folded end portion is from about 20% to about 35% of the length of the slice.

14. A method of configuring a slice of a pizza-type pie, which is at least partially baked, which method comprises:
folding an end portion of the slice, which end portion is substantially free of toppings, in a transverse direction so that the top of the end portion is folded onto the top of the remainder of the slice, which remainder has one or more toppings; and
folding the resulting slice in a lengthwise direction so that the top of the resulting slice is folded onto itself.

15. The method of claim 16, wherein the folded end portion of the slice is further substantially free of sauce.

16. The method of claim 14, wherein the slice is in a shape that is selected from the group consisting of a wedge shape, a substantially round shape, and a substantially square shape.

17. The method of claim 16, wherein the folded end portion is from about 10% to about 40% of the length of the slice.

18. The method of claim 17, wherein the folded end portion is from about 20% to about 35% of the length of the slice.

19. A method of configuring a wedge-shaped slice of a pizza-type pie, which is at least partially baked, which method comprises:
folding a pointed end portion of the slice, which end portion is substantially free of toppings, in a transverse direction so that the top of the end portion is folded onto the top of the remainder of the slice, which remainder has one or more toppings; and
folding the resulting slice in a lengthwise direction so that the top of the resulting slice is folded onto itself.

20. The method of claim 19, wherein the folded end portion of the slice is further substantially free of sauce.

21. The method of claim 19, wherein the folded end portion is from about 10% to about 40% of the length of the slice.

22. A configuration of a slice of a pizza-type pie, which is at least partially baked, which slice is obtained from the method comprising:
folding an end portion of the slice, which end portion is substantially free of toppings, in a transverse direction so that the top of the end portion is folded onto the top of the remainder of the slice, which remainder has one or more toppings; and
folding the resulting slice in a lengthwise direction so that the top of the resulting slice is folded onto itself.

23. The product of claim 22, wherein the folded end portion of the slice is further substantially free of sauce.

24. The product of claim 22, wherein the slice is in a shape that is selected from the group consisting of a wedge shape, a substantially round shape, and a substantially square shape.

25. The product of claim 24, wherein the folded end portion is from about 10% to about 40% of the length of the slice.

26. The product of claim 25, wherein the folded end portion is from about 20% to about 35% of the length of the slice.

27 A configuration of a wedge-shaped slice of a pizza-type pie, which is at least partially baked, which slice is obtained from the method comprising:
folding a pointed end portion of the slice, which end portion is substantially free of toppings, in a transverse direction so that the top of the end portion is folded onto the top of the remainder of the slice, which remainder has one or more toppings; and
folding the resulting slice in a lengthwise direction so that the top of the resulting slice is folded onto itself.

28. The product of claim 27, wherein the folded end portion of the slice is further substantially free of sauce.

29. The product of claim 27, wherein the folded end portion is from about 10% to about 40% of the length of the slice.

30. A pizza-type pie, comprising:
a crust;
sauce on top of the surface of the crust; and
toppings also on top of the surface of the crust;
wherein an inner minority portion of the surface area of the pizza is substantially free of toppings.

31. The pizza-type pie of claim 30, wherein the inner minority portion is further substantially free of sauce.

32. The pizza-type pie of claim 30, wherein the inner minority portion is from about 10% to about 40% of the surface area of the pizza.

33. A substantially round pizza-type pie, comprising:
a crust; and
toppings and sauce covering an annular region of the crust,
wherein an inner central region of the crust is substantially free of toppings.

34. The pizza-type pie of claim 33, wherein the inner central region is further substantially free of sauce.

35. The pizza-type pie of claim 33, wherein the central region has a substantially round shape.

36. The pizza-type pie of claim 35, wherein the central region comprises from about 10% to about 40% of the surface area of the pie.

37. A substantially square pizza-type pie, comprising:
a crust; and
toppings and sauce covering one or more rectangular regions of the crust,
wherein one or more inner rectangular regions of the crust is substantially free of toppings.

38. The pizza-type pie of claim 37, wherein the one or more inner rectangular regions are further substantially free of sauce.

39. The pizza-type pie of claim 37, wherein the one or more inner rectangular regions comprise from about 10% to about 40% of the surface area of the pie.

40. A slice of a pizza-type pie, which is at least partially baked, which slice comprises:
a crust;
a minor portion of the crust that is substantially free of toppings; and
toppings and sauce on the remainder of the crust.

41. The food item of claim 40, wherein the minor portion is further substantially free of sauce.

42. The food item of claim 40, wherein the slice is in a shape that is selected from the group consisting of a wedge shape, a substantially round shape, and a substantially square shape.

43. A toppings shield for use on substantially square pizza-type pies, comprising:
a strip of solid material formed to have a U-shaped cross-section.

44. The article of claim 43, wherein the solid material formed to have a house-shaped cross-section.

45. A toppings shield for use on substantially round pizza-type pies, comprising:
a top portion;
a substantially-cylindrical wall, wherein the top of the wall is connected to the periphery of the top portion; and
a plurality of spokes extending from the cylindrical wall, wherein the spokes have a U-shaped cross-section.

46. The article of claim 45, wherein the spokes have a house-shaped cross-section.

47. The article of claim 45, wherein the substantially-cylindrical wall has the shape selected from the group consisting of a circle, oval, an ellipse, a polygon or any similar geometric shape thereof, when viewed from the bottom.

48. The article of claim 45 further comprising a wheel to which the other end of the plurality of spokes are connected, wherein the wheel has a U-shaped cross-section.

49. The article of claim 48, wherein the wheel has a house-shaped cross-section.
